(19) United States
(12) Patent Application Publication
(10) Pub. No.: US 2011/0109666 A1
(43) Pub. Date: May 12, 2011

(54) LIQUID CRYSTAL DISPLAY DEVICE

(75) Inventors: Misa Owa, Kokubunji (JP); Junichi Maruyama, Mobara (JP); Goki Toshima, Chiba (JP); Yoshihisa Ooishi, Yokohama (JP)

(73) Assignee: Hitachi Displays, Ltd.

(21) Appl. No.: 12/942,151

(22) Filed: Nov. 9, 2010

(30) Foreign Application Priority Data
Nov. 10, 2009 (JP) 2009-257473

(51) Int. Cl. G09G 3/36; G09G 5/10

(52) U.S. Cl. 345/690; 345/89

(57) ABSTRACT

A liquid crystal display device includes data lines, a plurality of pixel circuits, and a control circuit which obtains data line potentials which are formed by correcting potentials which allow the respective pixel circuits to display tones. The control circuit obtains the data line potentials such that a correction amount from a first potential to the data line potential when a tone potential in a frame which is displayed is the first potential and a tone potential in a frame right before the frame is a second potential, and a correction amount from the second potential to the data line potential when the tone potential of the frame which is displayed is the second potential and the tone potential of the frame right before the frame is the first potential differ from each other.

### CLAIM OF PRIORITY

The present application claims priority from Japanese application JP 2009-257473 filed on Nov. 10, 2009, the content of which is hereby incorporated by reference into this application.

### BACKGROUND OF THE INVENTION

1. Field of the Invention

The present invention relates to a liquid crystal display device.

2. Description of the Related Art

Recently, a liquid crystal display device has been popularly used in a television receiver set, a monitor of a personal computer or the like. FIG. 13 shows a constitutional example of a conventional liquid crystal display device. The liquid crystal display device includes a liquid crystal display panel 110, a data line drive circuit 120, a scanning line drive circuit 130, and a control circuit 140. The liquid crystal display panel 110 is constituted of an array substrate and a counter substrate. On the array substrate, a plurality of data lines 121 which extend in the longitudinal direction in the drawing and a plurality of scanning lines 131 which extend in the lateral direction in the drawing are formed. A region which is surrounded by two neighboring data lines 121 and two neighboring scanning lines 131 forms one pixel circuit. One pixel circuit corresponds to one sub pixel. Three kinds of sub pixels of R, G, B form a group, and each group constitutes a pixel in a display region. Here, each pixel circuit includes a TFT (thin film transistor) element and a pixel electrode. Either one of a source electrode and a drain electrode of the TFT element included in each pixel circuit is connected to either one of two data lines which sandwich the pixel circuit. The other of the source electrode and the drain electrode is connected to the pixel electrode. Hereinafter, intensity of light of each sub pixel which is outputted through a color filter is referred to as display tone.

The data line drive circuit 120 is connected to the plurality of respective data lines 121 in the display panel 110. The data line drive circuit 120 generates a data line potential applied to the respective data lines 121. The scanning line drive circuit 130 is connected to the plurality of respective scanning lines 131 in the display panel 110. The scanning line drive circuit 130 generates a scanning line potential applied to the respective scanning lines 131.

The control circuit 140 is a circuit which controls an operation of the data line drive circuit 120 and an operation of the scanning line drive circuit 130. The control circuit 140 includes a polarity signal generation part 141, a data line control signal generation part 142, a reference voltage control part 143, and a scanning line control signal generation part 144. The polarity signal generation part 141 generates a polarity signal PS of a data line potential outputted from the data line drive circuit 120.

The data line control signal generation part 142 generates an image data control signal DS which allows the data line drive circuit 120 to output a data line potential corresponding to image data DD for every fixed period expressed by timing data SS.

The reference voltage control part 143 decides a pattern of a reference voltage which is used when the data line drive circuit 120 performs DA conversion, and outputs a reference voltage signal RS to a reference voltage generation part 150. The reference voltage generation part 150, based on the reference voltage signal RS, generates a reference voltage RV which becomes the reference of the data line potential corresponding to each display tone.

The data line drive circuit 120 generates a data line potential corresponding to display tone of each sub pixel based on the inputted image data control signal DS, the polarity signal PS and the reference voltage RV, and outputs the data line potential to each data line 121.

The scanning line control signal generation part 144 generates a video timing control signal VS for controlling the scanning line drive circuit 130 based on the timing data SS. The scanning line drive circuit 130, based on the video timing control signal VS, outputs a scanning line signal to the scanning line 131 so as to perform an ON/OFF control of the TFT element connected to the scanning line 131.

The liquid crystal display device, based on the image data DD, displays an image to be displayed in a switching manner on the display region at every predetermined period. Accordingly, a viewer of the liquid crystal display device can observe a moving image. Hereinafter, an image displayed in the display region one time is referred to as a 1 frame, and a period of 1 frame is referred to as a 1 frame period. Here, when a potential of the same polarity is continuously applied to liquid crystal, a ghost image or the like is formed. To avoid the formation of the ghost image, AC driving which reverses the polarity of a potential applied to the data line 121 every time a certain number of frames are displayed is performed. There also may be a case where when a potential of the same polarity is applied to each pixel circuit at certain timing via the data line, image quality is degraded due to a reason such as a deviation of a common potential. To prevent these drawbacks, an AC drive method such as line inversion which changes polarities of potentials applied to pixel electrodes of pixel circuits on neighboring lines or dot inversion which reverses polarities of potentials applied to pixel electrodes of neighboring pixel circuits is performed. JP 10-90712 A discloses a line-inversion AC drive method.

When a change of image data between two continuous frames is large, there may be a case where a change of liquid crystal cannot follow such a change of image data thus forming a display image whose profile is blurred. To overcome this drawback, there has been known an overdrive method which accelerates a change of liquid crystal by applying a data line potential which is at a higher level or at a lower level compared to a potential for displaying target tone to liquid crystal. JP 2002-062850 A discloses such a method. On the other hand, as one of methods which enhance a moving image performance of a liquid crystal display device so as to decrease blurring of a moving image, a drive method which increases the number of frames of image data to be displayed within a fixed time (hereinafter referred to as high frame rate driving) has been developed. This technique is disclosed in ““82” Ultra Definition LCD Using New Driving Scheme and Advanced Super PVA Technology” (SID 08, Sang Soo Kim).

Further, JP 9-258167 A discloses a method which optimizes response of liquid crystal in inversion driving as follows. That is, by making use of dielectric anisotropy of a liquid crystal material, a voltage which drives liquid crystals is corrected by taking whether a potential applied to a data line in a certain frame has positive polarity or negative polarity into consideration.

In a liquid crystal display device, the higher a frame rate, the shorter a time for writing image data by applying a data line potential to a pixel electrode becomes. When the image data writing time becomes shorter, there arises a phenomenon where a potential applied to a pixel electrode is not sufficiently changed to a potential which allows a pixel circuit to display an original display tone shown by image data (writing shortage of image data). The writing shortage of image data brings about the degradation of image quality such as a color shift of image data to be displayed originally.

In a conventional overdrive method, an amount of writing shortage of image data is calculated based on a display tone in a frame where image data is written and a display tone in a frame right before the above-mentioned frame, and the correction is made so as to cancel the amount of writing shortage of image data. However, there may be a case where the correction performed by this correction method is insufficient or brings about the excessive correction thus giving rise to degradation of image quality.

### SUMMARY OF THE INVENTION

It is an object of the present invention to provide a liquid crystal display device which can suppress the degradation of image quality more effectively than a case where the correction is made based on the difference in display tone.

To briefly explain typical inventions among inventions disclosed in this specification, they are as follows.

(1) According to one aspect of the present invention, there is provided a liquid crystal display device which includes: a data line; a plurality of pixel circuits each of which includes a transistor and a pixel electrode; a data line drive circuit which applies a data line potential to the transistor included in said each pixel circuit via the data line; and a control circuit which allows the data line drive circuit to apply the data line potential which is formed by correcting a tone potential which allows the pixel circuit to display a display tone thereof based on information indicative of the display tone of said each pixel circuit, wherein the pixel electrode which is included in said each pixel circuit is connected to the data signal line via the transistor included in the pixel circuit, and the control circuit controls the data line drive circuit in such a manner that an amount of correction from a first potential to the data line potential when a tone potential of said each pixel circuit in a frame which is displayed assumes the first potential and a tone potential of the pixel circuit in a frame right before the frame which is displayed assumes a second potential which differs from the first potential, and an amount of correction from the second potential to the data line potential when the tone potential of said each pixel circuit in the frame which is displayed assumes the second potential and the tone potential of the pixel circuit of the frame right before the frame which is displayed assumes the first potential differ from each other.

(2) In the liquid crystal display device in (1), the control circuit controls the data line drive circuit in such a manner that an amount of correction from a positive potential to the data line potential when the tone potential of said each pixel circuit in the frame which is displayed assumes the positive potential and the tone potential of the pixel circuit of the frame right before the frame which is displayed assumes a negative potential, and an amount of correction from the negative potential to the data line potential when the tone potential of said each pixel circuit in the frame which is displayed assumes the negative potential and the tone potential of the pixel circuit of the frame right before the frame which is displayed assumes the positive potential differ from each other.

(3) In the liquid crystal display device in (2), the control circuit includes: a tone potential calculation part which obtains a value indicative of a tone potential which allows the pixel circuit to display the display tone based on information indicative of the display tone; a tone potential correction part which outputs a value indicative of an enhanced potential which is formed by correcting the tone potential of the frame which is displayed based on potential difference between the tone potential of the frame which is displayed and the tone potential of the frame right before the frame which is displayed; a polarity correction part which outputs data indicative of the data line potential which is formed by correcting the enhanced potential based on polarity of a potential applied to the pixel electrode in the frame which is displayed and polarity of a potential applied to the pixel electrode in the frame right before the frame which is displayed; and a data line control signal generation part which performs a control so as to allow the data line drive circuit to apply the data line potential.

(4) The liquid crystal display device in (3) further includes a temperature observation part which measures a temperature, and the tone potential correction part calculates a value indicative of the enhanced potential based on information indicative of the display tone and the measured temperature.

(5) In the liquid crystal display device in (1) or (2), the control circuit includes: a storage means which stores values indicative of the data line potentials corresponding to the display tone and the polarity of the frame which is displayed and the display tone and the polarity of the frame right before the frame which is displayed; and a data line control signal generation means which performs a control such that the data line drive circuit applies the data line potential based on information indicative of the display tone of said each pixel circuit, a polarity of the potential applied to the data line in the frame which is displayed, a polarity of the potential applied to the data line in the frame right before the frame which is displayed, and the values indicative of the data line potentials stored in the storage means.

(6) In the liquid crystal display device in any one of (2) to (5), the control circuit inverts the polarity of the potential which the data line drive circuit applies to the data line every time 2 or more predetermined frames are displayed.

(7) In the liquid crystal display device in any one of (1) to (6), the control circuit further includes a frame rate conversion means which acquires image data of a frame rate lower than a frame rate at which the control circuit is operated and converts the image data into information indicative of the display tone at the frame rate at which the control circuit is operated.

According to the present invention, it is possible to provide the liquid crystal display device which can suppress the degradation of image quality more effectively than a case where the correction is made based on the difference in display tone.

### BRIEF DESCRIPTION OF THE DRAWINGS

FIG. 1 is a block diagram showing an example of a liquid crystal display device according to a first embodiment of the present invention;

FIG. 2 is a circuit diagram showing one example of a pixel circuit;

FIG. 3 is a graph showing waveforms of scanning line potentials outputted from a scanning line drive circuit;

FIG. 4A is a graph showing examples of waveforms of a potential of a pixel electrode when a data line potential is applied at a low frame rate;

FIG. 4B is a graph showing examples of waveforms of a potential of a pixel electrode when a data line potential is applied at a high frame rate;

FIG. 5A is a graph for explaining the relationship between a tone potential and an enhanced potential;

FIG. 5B is a graph for explaining the relationship between a tone potential and an enhanced potential;

FIG. 6 is a graph showing the relationship between a tone potential and an enhanced potential;

FIG. 7 is a graph showing the difference in a potential change of a pixel electrode depending on polarities;

FIG. 8A is a timing chart showing a change of polarity of a data line potential when 1 frame inversion is performed with low frame rate driving;

FIG. 8B is a timing chart showing a change of polarity of a data line potential when 1 frame inversion is performed with high frame rate driving;

FIG. 8C is a timing chart showing a change of polarity of a data line potential when 2 frame inversion is performed with high frame rate driving;

FIG. 9A is a chart showing an example of a potential change of a pixel electrode when polarity is changed from positive polarity to negative polarity between frames without the correction of a data line potential;

FIG. 9B is a chart showing an example of a potential change of a pixel electrode when polarity is changed from negative polarity to positive polarity between frames without the correction of a data line potential;

FIG. 9C is a chart showing an example of a potential change of a pixel electrode when polarity is changed from negative polarity to negative polarity between frames without the correction of a data line potential;

FIG. 9D is a chart showing an example of a potential change of a pixel electrode when polarity is changed from positive polarity to positive polarity between frames without the correction of a data line potential;

FIG. 10A is a chart showing an example of a potential change of a pixel electrode when polarity is changed from positive polarity to negative polarity between frames with the correction of a data line potential;

FIG. 10B is a chart showing an example of a potential change of a pixel electrode when polarity is changed from negative polarity to positive polarity between frames with the correction of a data line potential;

FIG. 10C is a chart showing an example of a potential change of a pixel electrode when polarity is changed from negative polarity to negative polarity between frames with the correction of a data line potential;

FIG. 10D is a chart showing an example of a potential change of a pixel electrode when polarity is changed from positive polarity to positive polarity between frames with the correction of a data line potential;

FIG. 11 is a block diagram showing an example of a liquid crystal display device according to a second embodiment of the present invention; and

FIG. 12 is a block diagram showing an example of a liquid crystal display device according to a third embodiment of the present invention; and

FIG. 13 is a block diagram showing an example of a conventional liquid crystal display device.

### DETAILED DESCRIPTION OF THE INVENTION

Hereinafter, a liquid crystal display device according to embodiments of the present invention is explained in conjunction with drawings. In the drawings, the same or equivalent elements will be denoted by the same reference characters, and the repeated explanation of these elements is omitted. Hereinafter, the explanation is made with respect to a liquid crystal display device which adopts TFT elements.

### First Embodiment

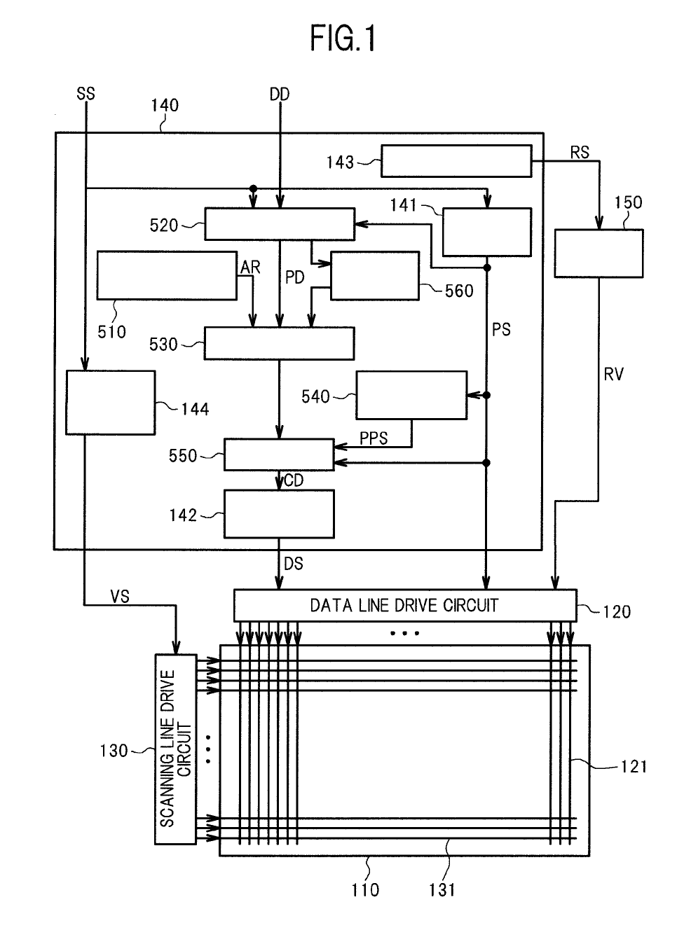

FIG. 1 shows an example of a liquid crystal display device according to a first embodiment of the present invention. The liquid crystal display device according to the first embodiment includes a liquid crystal display panel 110, a data line drive circuit 120, a scanning line drive circuit 130, and a control circuit 140. The liquid crystal display panel 110 is constituted of an array substrate and a counter substrate which is arranged to face the array substrate in an opposed manner. Liquid crystal is sealed in a space defined between the array substrate and the counter substrate. On the array substrate, a plurality of data lines 121 which extend in the longitudinal direction in the drawing and a plurality of scanning lines 131 which intersect with the data lines 121 and extend in the lateral direction in the drawing are formed. A region which is surrounded by two neighboring data lines 121 and two neighboring scanning lines 131 forms a pixel circuit for displaying one sub pixel. The pixel circuits are arranged within a display region on the array substrate in a matrix array. One pixel within the display region of the liquid crystal display device is constituted of a group consisting of three kinds of sub pixels of R, G, B. In the liquid crystal display device, an image is displayed in the display region by a mass of pixels, and a moving image is displayed in the display region by changing over the image at fixed intervals.

The data line drive circuit 120 is connected to the plurality of respective data lines 121 in the liquid crystal display panel 110. The data line drive circuit 120 generates data line potentials applied to the respective data lines 121. The scanning line drive circuit 130 is connected to the plurality of respective scanning lines 131 in the liquid crystal display panel 110. The scanning line drive circuit 130 generates scanning line potentials applied to the respective scanning lines 131.

The control circuit 140 is a circuit which controls an operation of the data line drive circuit 120 and an operation of the scanning line drive circuit 130. The control circuit 140 includes a polarity signal generation part 141, a data line control signal generation part 142, a reference voltage control part 143, a scanning line control signal generation part 144, a tone potential arrival rate output circuit 510, a tone potential calculation circuit 520, a tone potential correction circuit 530, a frame polarity storage part 540, a polarity correction circuit 550 and a tone potential storage part 560. The liquid crystal display device also includes a reference voltage generation part 150 which is connected to the data line drive circuit 120. The reference voltage generation part 150 is also connected to the reference voltage control part 143.

The polarity signal generation part 141 generates a polarity signal PS indicative of polarity of the data line potential outputted from the data line drive circuit 120. The reference voltage control part 143 decides a pattern of a reference voltage which is used when the data line drive circuit 120 performs DA conversion, and outputs a reference voltage signal RS indicative of the pattern of the reference voltage to the reference voltage generation part 150. The reference voltage generation part 150, based on the reference voltage signal RS, generates a reference voltage RV which becomes the reference of the data line potential corresponding to each display tone. Here, the data line potential has positive polarity and negative polarity. The positive polarity indicates that the potential is higher than a reference potential Vcom and the negative polarity indicates that the potential is lower than the reference potential Vcom.

The tone potential arrival rate output circuit 510, the tone potential calculation circuit 520, the tone potential correction circuit 530, the frame polarity storage part 540 and the polarity correction circuit 550 are provided for outputting data line potential data CD. Here, the data line potential data CD indicates a data line potential which is formed by correcting a tone potential Vd so as to allow respective pixel circuits to display tone which the inputted image data DD indicates. Specific contents of these parts are explained later. The data line control signal generation part 142 generates an image data control signal DS from the data line potential data CD. The image data control signal DS is provided for controlling the data line drive circuit 120 such that the data line drive circuit 120 applies the data line potential which the data line potential data CD indicates to the data lines 121 at proper timing.

The data line drive circuit 120 acquires the image data control signals DS, the polarity signals PS and the reference voltages RV, and generates data line potentials corresponding to the respective display tones. The generated data line potentials are applied to the respective data lines 121. When the polarity signal PS is a potential of high level, the data line drive circuit 120 applies the data line potential of positive polarity to the data line 121, while when the polarity signal PS is a potential of low level, the data line drive circuit 120 applies the data line potential of negative polarity to the data line 121.

The scanning line control signal generation part 144 generates a video timing control signal VS for controlling the scanning line drive circuit 130 based on timing data SS inputted to the control circuit 140. The scanning line drive circuit 130, based on the video timing control signal VS inputted from the scanning line control signal generation part 144, outputs a scanning line signal GS to the scanning lines 131.

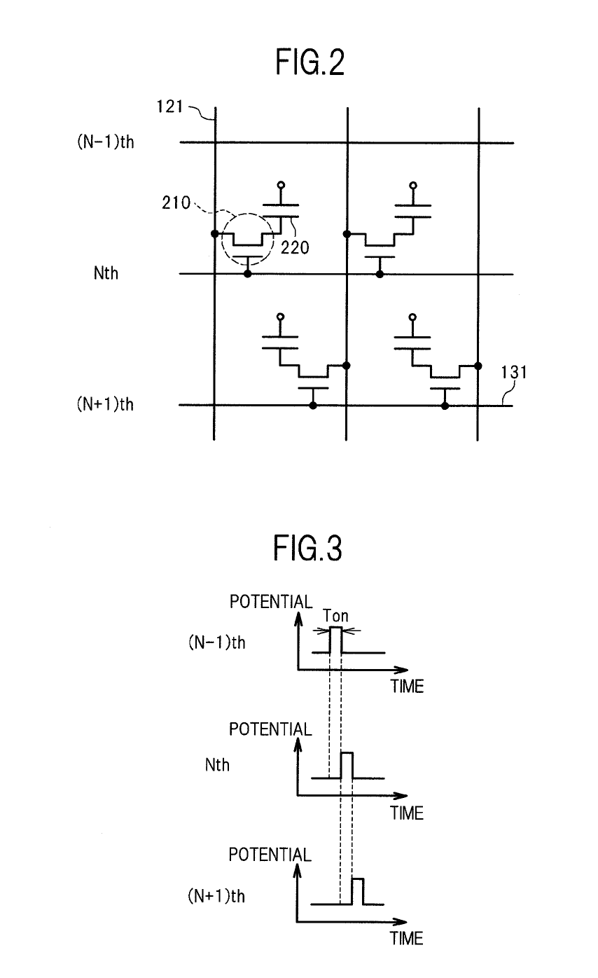

FIG. 2 shows one example of the pixel circuit. Each pixel circuit includes a TFT (thin film transistor) element 210 and a pixel electrode 220. Either one of a source electrode and a drain electrode of the TFT element 210 included in each pixel circuit is connected to either one of two data lines 121 which sandwich the pixel circuit. The other of the source electrode and the drain electrode is connected to the pixel electrode 220 included in each pixel circuit. A gate electrode of the TFT element 210 is connected to the scanning line 131. Whether the electrode of the TFT element 210 is the drain electrode or the source electrode is determined based on difference in level between potentials applied to the drain electrode or the source electrode respectively. This is because the TFT element 210 has no polarity. Hereinafter, for the sake of convenience, the electrode connected to the data line 121 is referred to as the drain electrode and the electrode connected to the pixel electrode 220 is referred to as the source electrode.

FIG. 3 shows waveforms of the scanning line signals GS outputted from the scanning line drive circuit 130. The scanning line signals GS are generated by the scanning line drive circuit 130 and are outputted to the respective scanning lines 131. A time during which a potential of high level is applied to each scanning line 131 is referred to as ON time Ton. When the potential of high level is applied to the scanning line 131, the TFT element 210 which is connected to the scanning line 131 electrically connects the pixel electrode 220 and the data line 121 to each other (bringing the pixel electrode 220 into an ON state). Next, the scanning line drive circuit 130 sets the potential of the scanning lines 131 at a high level to a low level and sets the potential of the next scanning lines 131 to a high level, and repeats such operations sequentially. When the TFT element 210 is brought into an ON state in response to the scanning line signal GS from the scanning line 131, the potential of the pixel electrode 220 is changed toward the data line potential applied to the drain electrode of the TFT element 210. An electric field is applied to liquid crystal in the vicinity of the pixel electrode 220 due to the potential of the pixel electrode 220. Accordingly, transmittance of light which passes through liquid crystal in the vicinity of the pixel electrode is changed by the electric field so that each pixel outputs a display tone corresponding to the data line potential.

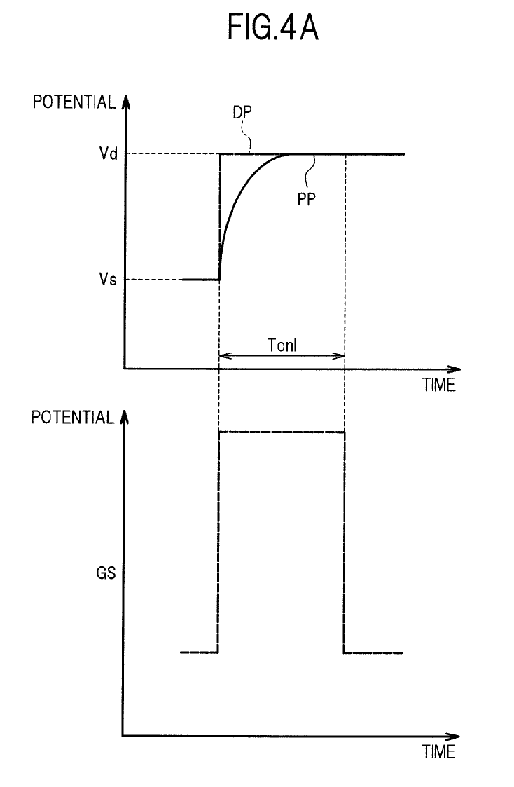

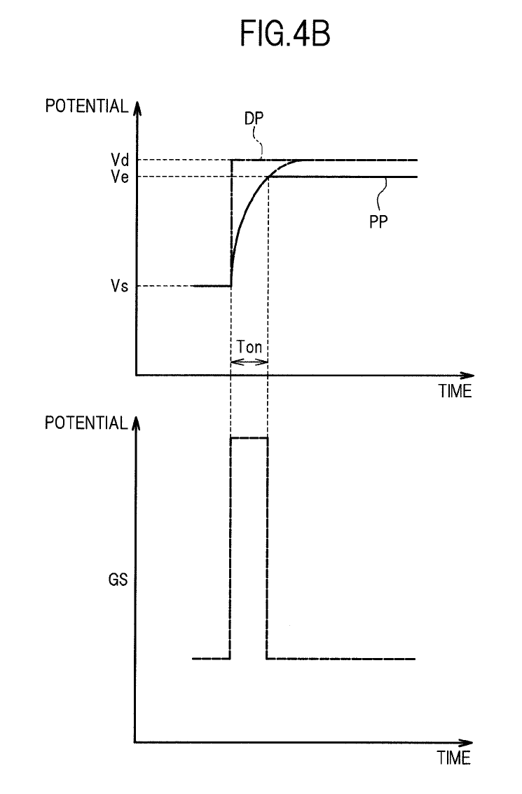

Next, the occurrence of writing shortage when the tone potential Vd obtained by the image data DD is applied to the data lines 121 is explained. FIG. 4A shows examples of waveforms of a pixel electrode potential PP which is a potential of the pixel electrode 220 when a data line potential DP is applied to the data lines 121 at a low frame rate. FIG. 4B shows examples of waveforms of the pixel electrode potential PP when the data line potential DP is applied at a high frame rate. Here, the low frame rate implies a frame rate of an image signal received in usual broadcasting or the like such as 60 Hz, for example, and the high frame rate implies a frame rate higher than the low frame rate such as a frame rate in double-speed driving, for example. As shown in FIG. 4A, when the scanning line signal GS is a signal of low frame rate, during a scanning line ON time Ton1, the tone potential Vd is applied to the data line 121 which is electrically connected to the pixel electrode 220 as the data line potential DP so that a signal indicative of display tone is written in the pixel electrode 220. The tone potential Vd is a potential which allows the pixel circuit to display the display tone which the image data DD indicates when the potential is applied to the data line 121 for a sufficiently long time.

Here, an RC circuit is constituted of resistance and capacitance which are generated by the pixel circuit and the data line 121. The pixel electrode potential PP changes from a potential Vs at the time of starting writing a signal to the potential Vd, and it takes time corresponding to a time constant of the RC circuit until such a potential change assumes a steady state. In low frame rate driving, the scanning line ON time Ton1 is set to a time sufficient for bringing the pixel electrode potential PP into a steady state.

However, as shown in FIG. 4B, when high frame rate driving is performed, the scanning line ON time Ton becomes shorter than the scanning line ON time Ton1 for low frame rate driving. A time for applying the data line potential DP to the pixel electrode 220 is decreased and hence, a time for writing a signal indicative of display tone is decreased. As a result, the scanning line ON time Ton ends before the pixel electrode potential PP assumes a steady state, and a potential Ve of the signal in the current frame at the time of completion of writing is applied to the pixel electrode 220 until another data line potential is written in the next frame. The deviation between Vd and Ve implies the writing shortage of the signal indicative of the display tone, and this writing shortage brings about image degradation such as a color shift.

The influence exerted by this writing shortage becomes more conspicuous in AC driving of the data line potential DP. The liquid crystal display device has a drawback that when a data line potential of same polarity is continuously applied to the pixel electrode, a ghost image occurs in a panel. To suppress the occurrence of the ghost image, AC driving which reverses polarity of the data line potential DP (same polarity as polarity of the tone potential Vd) at fixed frame intervals is performed. In this embodiment, liquid crystal in a normal black mode is used so that the brighter the display tone, the difference between the tone potential Vd and the reference potential Vcom is increased. In the same display tone, the difference between the tone potential Vd of positive polarity and the reference potential Vcom and the difference between the tone potential Vd of negative polarity and the reference potential Vcom are equal to each other.

Under such circumstances, when the polarity is reversed between the frame in which writing is performed and the previous frame, the potential difference between the potential before the data line potential DP is applied and the tone potential Vd is increased and the deviation is also increased along with the increase of the potential difference. Particularly when the polarity changes, the large potential difference is generated even when the display tone is not changed between the frames. Accordingly, it is understood that a quantity of the pixel electrode potential PP to be changed changes depending on polarities of preceding and succeeding frames even when the image data is the same.

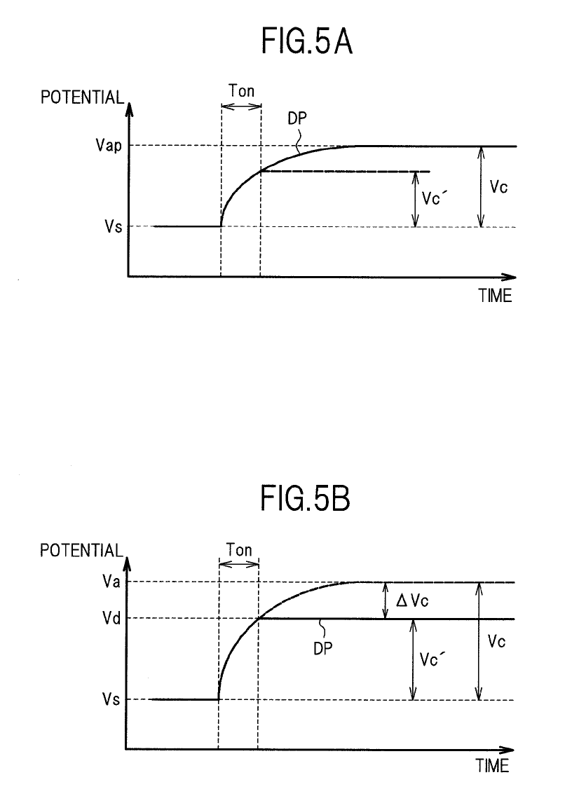

Next, the concept of correction which copes with such writing shortage attributed to the above-mentioned RC circuit is explained. FIG. 5A and FIG. 5B are graphs for explaining the relationship between the tone potential Vd and an enhanced potential Va. The enhanced potential Va is a potential which is corrected so that the tone potential Vd cancels the influence exerted by the RC circuit. FIG. 5A is a graph showing a change of the pixel electrode potential PP when the data line drive circuit 120 applies a potential Vap to the data line 121 until the potential Vap assumes a steady state. Here, the potential PP of the pixel electrode 220 before the potential Vap is applied to the data line 121 is referred to as Vs. When the influence other than the influence exerted by the RC circuit is ignored, a theoretical formula of a potential difference V(t) between the pixel electrode potential PP and Vs at a point of time t from turning on of the scanning line (the TFT element 210) is expressed as follows.

$$V ( t ) = Vc ( 1 - {e}^{- \frac{t}{RC}} ) \qquad [ Formula 1 ]$$

Here, the relationship of Vc=Vap−Vs is established, wherein Vc indicates a potential difference between the potential Vap applied to the data line 121 when the scanning line is turned on and the potential Vs of the pixel electrode 220 before the scanning line ON period Ton. A change of the pixel electrode potential PP with time obtained based on the potential difference V(t) is shown in FIG. 5A. From the above, it is understood that the potential difference V(Ton) at a point of time that the scanning line ON period Ton is finished is expressed as follows.

$$V ( Ton ) = Vc ( 1 - {e}^{- \frac{Ton}{RC}} ) \qquad [ Formula 2 ]$$

FIG. 5B is a view showing a change of the pixel electrode potential PP with time when the influence exerted by the RC circuit is corrected. Here, a potential at a point of time t2 is the tone potential Vd, and it is assumed that the enhanced potential Va is applied to the pixel electrode 220 during the scanning line ON period Ton. From the above-mentioned formula, it is understood that it is sufficient to obtain the enhanced potential Va which satisfies the following formula.

$${Vc}^{′} = Vd - Vs = ( Va - Vs ) Ra \\ Ra = ( 1 - {e}^{- \frac{Ton}{RC}} ) \qquad [ Formula 3 ]$$

Here, Ra is referred to as a tone potential arrival rate. The scanning line ON period Ton is determined based on a frame rate and hence, when the frame rate is determined, the tone potential arrival rate is determined. By applying the enhanced potential Va calculated based on the tone potential arrival rate to the data line 121, it is possible to eliminate the writing shortage generated by the RC circuit. Here, to compare the enhanced potential Va and the tone potential Vd, when the relationship of Vs<Vd is established, the relationship of Vd<Va is established. On the other hand, when the relationship of Vs>Vd is established, the relationship of Vd>Va is established.

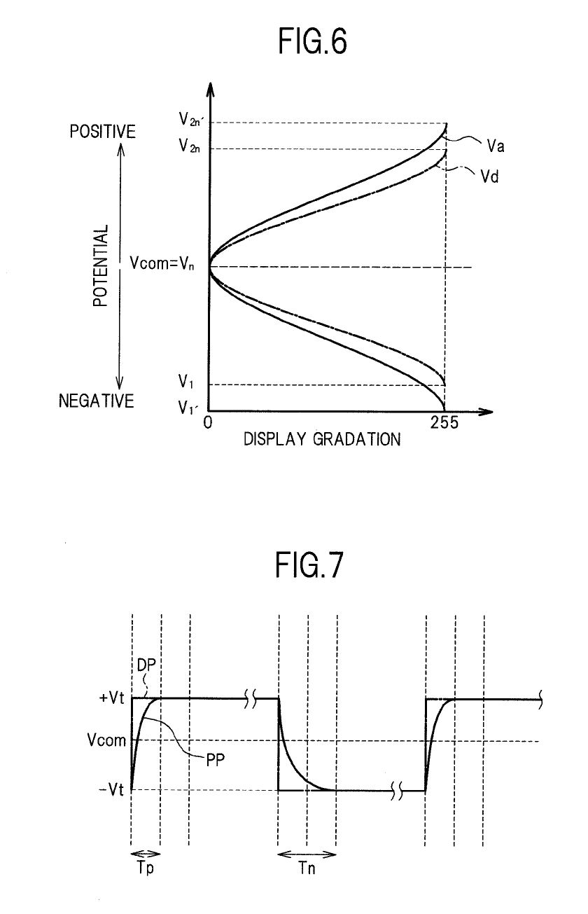

FIG. 6 shows the relationship among a display tone, the tone potential Vd and the enhanced potential Va. FIG. 6 shows the above-mentioned relationship when Vs is the reference potential Vcom. In a graph shown in FIG. 6, the display tone is taken on an axis of abscissas and the potential is taken on an axis of ordinates. The reference potential Vcom is a potential which becomes the reference in polarity inversion, wherein in the same tone, the potential difference between the tone potential Vd of positive polarity and the reference potential Vcom and the potential difference between the tone potential Vd of negative polarity and the reference potential Vcom are equal to each other in magnitude. The difference between the enhanced potential Va and the reference potential Vcom is set larger than the difference between the tone potential Vd and the reference potential Vcom.

In an actual operation, besides the above-mentioned writing shortage attributed to the RC circuit, the deviation between the tone potential Vd and the pixel electrode potential PP attributed to a level of the data line potential DP per se is generated. As shown in FIG. 2, each data line 121 which supplies a potential is connected to the pixel electrode 220 via the TFT element 210. This constitution is asymmetrical with respect to polarity. For example, a high level potential and a low level potential of the scanning line signal GS supplied from the scanning line 131 are fixed irrelevant to polarity of a data line potential. Due to such a constitution, between a case where a data line potential of positive polarity is inputted to the pixel circuit and a case where a data line potential of negative polarity is inputted to the pixel circuit, even when the potential difference between the pixel electrode 220 and the data line potential is the same, the magnitude of an electric current which flows toward the pixel electrode 220 differs.

FIG. 7 is a view showing the difference in potential change of the pixel electrode 220 depending on polarities. The drawing shows a change of the pixel electrode potential PP by assuming a case where, as the data line potential DP, a high potential +Vt and a low potential −Vt are supplied to the pixel electrode 220 alternately for every sufficiently long time. As shown in FIG. 5, a rapidity of change of the pixel electrode potential PP differs between the case where the data line potential changes from a high potential to a low potential between the frames and a case where the data line potential changes from a low potential to a high potential between the frames. Accordingly, a time Tn which elapses until the pixel electrode potential PP assumes a steady state when the data line potential changes from the high potential +Vt to the low potential −Vt becomes longer than a time Tp which elapses until the pixel electrode potential PP assumes a steady state when the data line potential changes from the low potential −Vt to the high potential +Vt. In other words, when the scanning ON time Ton is short at the high frame rate or the like, the difference appears as the degradation of image quality. In the example of this embodiment, the potential applied to the data line 121 is 0 to 14V, the reference potential Vcom is 7V, and the high level potential and the low level potential of the scanning line signal GS are 30V and 0V respectively. In this case, a change of potential of the pixel electrode 220 is more delayed when the pixel electrode potential PP is changed from a high potential to a low potential. This phenomenon becomes particularly conspicuous when the polarity of the previous frame and the polarity of the succeeding frame differ from each other as in the example shown in FIG. 5.

Next, the explanation is made with respect to the correction of the deviation at the time of writing a signal indicative of display tone which occurs due to a level of the data line potential DP per se. From the relationship between the display tone and the tone potential, a potential in the vicinity of the reference potential Vcom is not applied and hence, a lower limit of a change amount of the tone potential when the polarity changes assumes a fixed value. Accordingly, the present invention focuses on a change of polarity in the tone potential Vd and the enhanced potential Va, and corrects a fixed potential determined in accordance with a polarity change pattern.

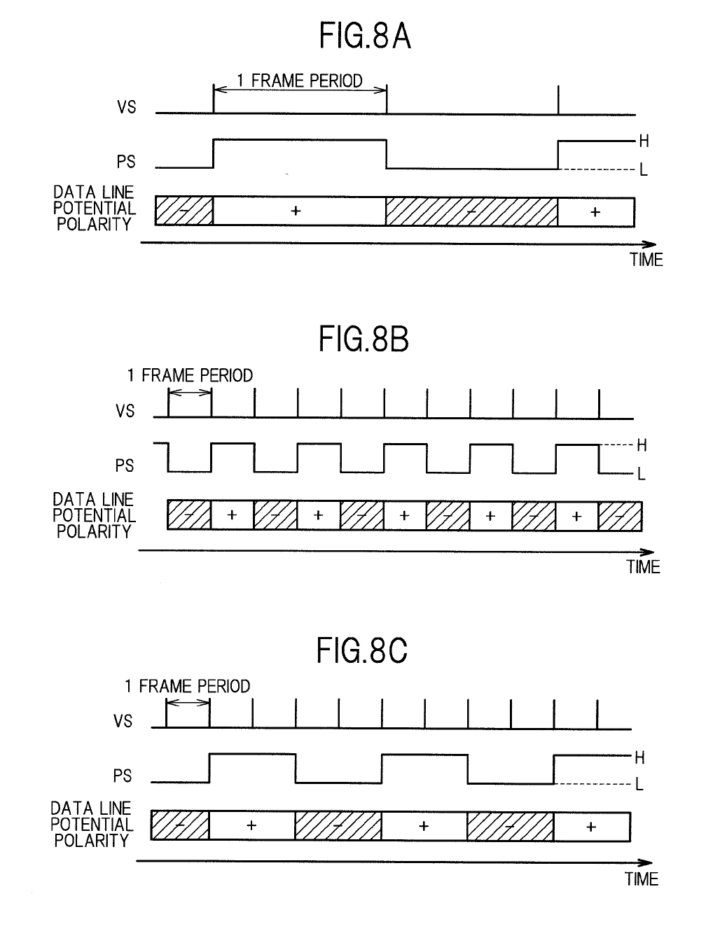

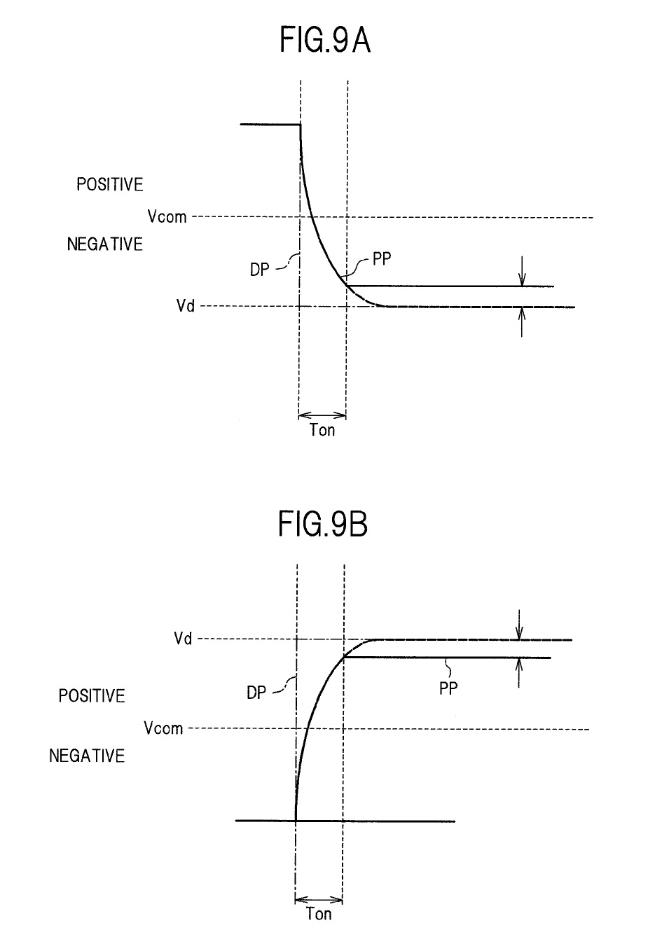

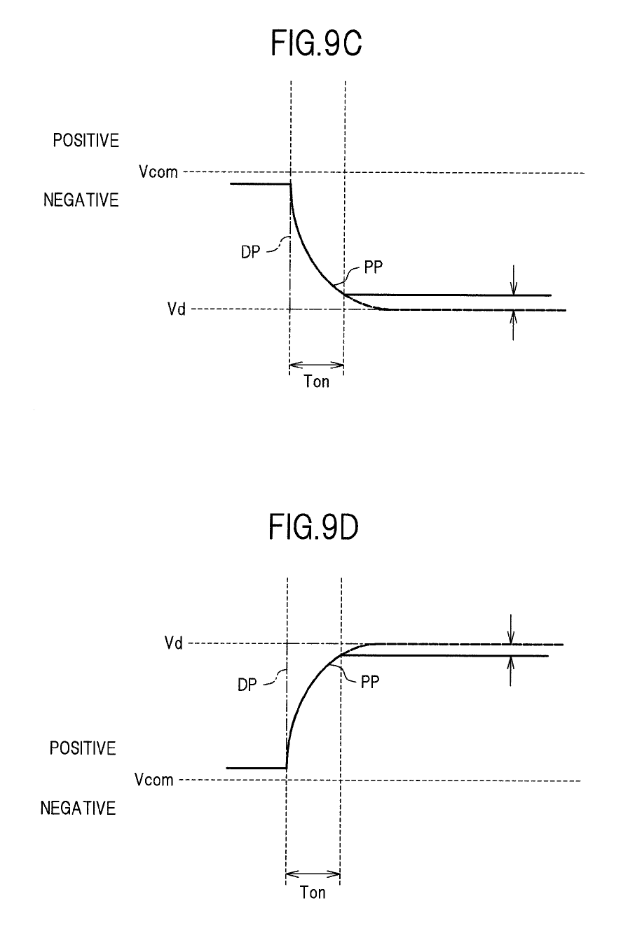

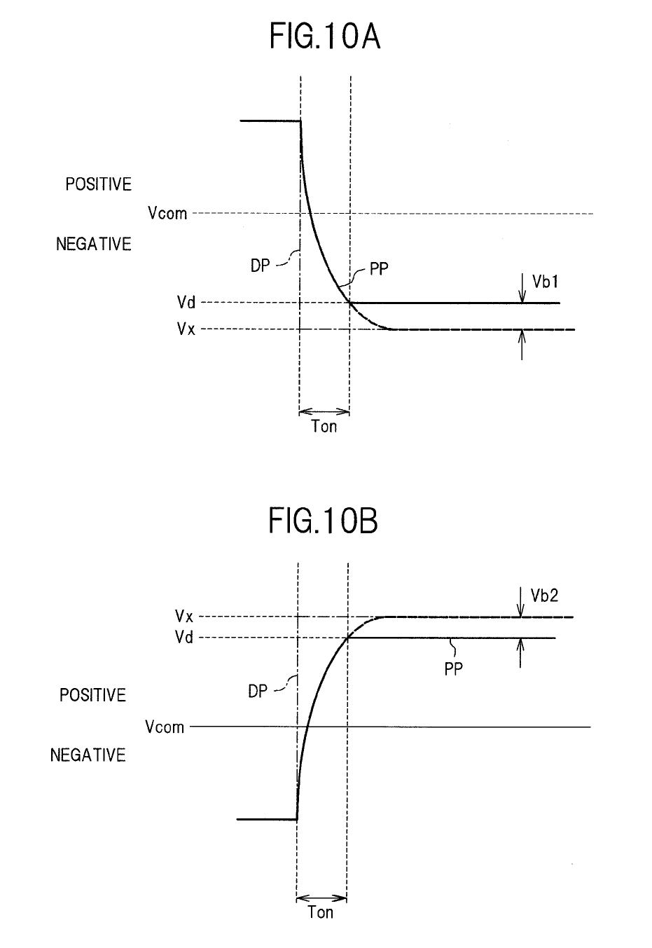

Here, the polarity inversion pattern is explained. FIG. 8A is a timing chart showing a change with time of polarity of the tone potential Vd when 1 frame inversion is performed with low frame rate driving. The image timing control signal VS assumes a high level potential for a short time at changeover timing of respective frames, and assumes a low level potential at other times. The polarity signal PS is changed over between a high level and a low level each time the image timing control signal VS assumes a high level. The polarity of the tone potential Vd assumes positive polarity when the polarity signal PS is at a high level and negative polarity when the polarity signal PS is at a low level. That is, in this case, 1 frame inversion where the polarity of the tone potential Vd is reversed for every 1 frame is performed. In general, when a frame rate becomes a frequency lower than 60 Hz, flickering occurs so that image quality is degraded.

FIG. 8B is a timing chart showing a change with time of polarity of the data line potential when 1 frame inversion is performed with high frame rate driving. In the drawing, as an example of a high frame rate, a case where a liquid crystal display device is driven at a frame rate 4 times higher than low frame rate driving is shown. In the high frame rate driving, a length of 1 frame period becomes a quarter of a length of 1 frame period in the low frame rate driving. When 1 frame inversion driving is performed in the same manner as the case shown in FIG. 8A, the number of charging and discharging of voltage applied to the pixel electrode 220 is increased. When the number of charging and discharging of voltage applied to the pixel electrode 220 is increased, the power consumption is increased. For example, in the case shown in FIG. 8B, the power consumption attributed to the potential applied to the data line 121 is increased approximately 4 times compared to the low frame rate driving.

FIG. 8C is a timing chart showing a change with time of polarity of the data line potential when 2 frame inversion driving is performed with high frame rate driving. In the same manner as FIG. 8B, FIG. 8C shows an example where the frame inversion driving is performed at a frame rate 4 times higher than the low frame rate driving. In this case, the polarity inversion is made every four frames and hence, the number of charging and discharging can be decreased thus suppressing the increase of the power consumption. For example, in the display device according to the present invention, the power consumption attributed to a potential applied to the data line 121 can be approximately halved compared to a case where 1 frame inversion driving shown in FIG. 8B is performed.

In this embodiment, the polarity inversion shown in FIG. 8C is performed. There are 4 kinds of inter-frame polarity patterns between a frame which is displayed and a frame right before the frame. Out of these 4 kinds of patterns, as the different-polarity patterns where the polarities change from each other, there are two patterns consisting of the pattern in which polarity is changed from positive polarity to negative polarity (hereinafter referred to as pattern 1) and the pattern in which polarity is changed from negative polarity to positive polarity (hereinafter referred to as pattern 2). Further, as the same-polarity patterns where the polarities do not change between the frames, there are two patterns consisting of the pattern in which polarity is changed from negative polarity to negative polarity (hereinafter referred to as pattern 3) and the pattern in which polarity is changed from positive polarity to positive polarity (hereinafter referred to as pattern 4). Correction amounts for deviations at the time of writing signals indicative of display tones are set corresponding to these respective patterns. Assuming the correction values for the pattern 1 to the pattern 4 as Vpc1, Vpc2, Vpc3 and Vpc4 respectively, the correction value Vpc1 is smaller than −Vpc2. Here, the correction values Vpc1, Vpc2, Vpc3 and Vpc4 may be determined empirically.

The generation of data line potential data CD in the control circuit 140 is explained in detail hereinafter. The tone potential arrival rate output circuit 510 outputs tone potential arrival rate data AR for the tone potential Vd by taking CR time constants of the data lines and peripheral circuits into consideration. The tone potential arrival rate data AR is data indicative of a tone potential arrival rate in the scanning line ON period Ton in high frame rate driving. The tone potential arrival rate output circuit 510 may calculate and output the tone potential arrival rate based on frame rates. Alternatively, the tone potential arrival rate output circuit 510 may store the tone potential arrival rate data AR which are calculated for respective frame rates in a memory and may take out and output the tone potential arrival rate data AR of an operating frame rate from the memory.

The tone potential calculation circuit 520 calculates the tone potential Vd which allows the pixel circuit to display the display tone which the image data DD indicates, and outputs tone potential data PD indicative of the tone potential Vd. In place of calculation of the tone potential Vd, data on the tone potential Vd which is preliminarily calculated for ever display tone may be stored in a memory, and data on the tone potential Vd corresponding to the display tone which the image data DD indicates may be taken out from the memory. Here, the information indicative of the tone potential is stored in the tone potential storage part 560 for every pixel, and is referenced by the tone potential correction circuit 530 in the next frame.

The tone potential correction circuit 530 performs the correction calculation of the tone potential based on the tone potential arrival rate data AR, the tone potential data PD of each pixel of the frame (hereinafter referred to as (M+1)th frame) which is displayed from the tone potential calculation circuit 520, and information indicative of the tone potential of one previous frame (hereinafter referred to as Mth frame) from the tone potential storage part 560. In this correction calculation, the data line writing potential in high frame rate driving is set to a value substantially equal to that of the tone potential. To be more specific, the enhanced potential Va is obtained by multiplying the potential difference between the tone potential which tone potential data 502 indicates and the tone potential of the Mth frame acquired from the tone potential storage part 560 by the inverse number of the tone potential arrival rate which the tone potential arrival rate data AR indicates, and by adding the tone potential of the Mth frame to the value obtained by multiplication. Then, the tone potential correction circuit 530 outputs enhanced potential data AD indicative of the enhanced potential Va.

The frame polarity storage part 540 acquires the polarity signal PS and holds the polarity signal PS until scanning in the next frame is finished. Then, the frame polarity storage part 540 outputs previous frame polarity data PPS indicative of polarity of the Mth frame. The polarity correction circuit 550 determines a pattern of polarity change between polarity of tone potential or enhanced potential of the Mth frame and polarity of tone potential or enhanced potential of the (M+1)th frame based on the polarity signal PS from the polarity signal generation part 141 and the previous frame polarity data PPS. The previous frame polarity data PPS from the frame polarity storage part 540 indicates the polarity of the previous frame. The polarity correction circuit 550 outputs the data line potential data CD indicative of the data line potential acquired by adding the correction potential corresponding to the pattern to the enhanced potential Va. Here, the correction potential corresponding to the pattern of polarity change is preliminarily obtained and is stored in a memory.

The data line control signal generation part 142 outputs the image data control signal DS. The image data control signal DS is information which allows the data line drive circuit 120 to output the potential after correction which the data line potential data CD indicates.

Advantages acquired by performing the above-mentioned correction are explained hereinafter. FIG. 9A to FIG. 9D are views showing examples of a potential change of the pixel electrode 220 when the above-mentioned correction of the data line potential is not performed. FIG. 9A shows an example of the potential change of the pixel electrode when polarity is changed from positive polarity to negative polarity between frames. FIG. 9B shows an example of the potential change of the pixel electrode when polarity is changed from negative polarity to positive polarity between frames. FIG. 9C shows an example of the potential change of the pixel electrode when polarity is changed from negative polarity to negative polarity between frames. FIG. 9D shows an example of the potential change of the pixel electrode when polarity is changed from positive polarity to positive polarity between frames. In the respective cases, the data line potential DP applied to the data line 121 during the scanning line ON period Ton is the tone potential Vd, and the difference between the tone potential Vd and the pixel electrode potential PP at a point of time that the scanning line ON period Ton elapses differs among the respective patterns.

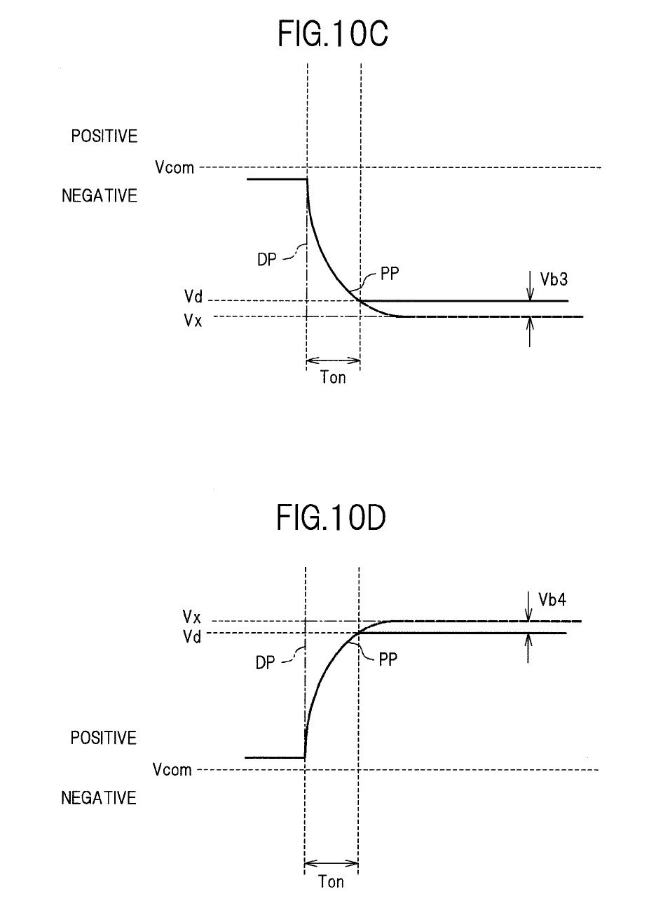

FIG. 10A to FIG. 10D are views showing examples of a potential change of the pixel electrode 220 when the above-mentioned correction of the data line potential is performed. FIG. 10A shows an example of the potential change of the pixel electrode when polarity is changed from positive polarity to negative polarity between frames. FIG. 10B shows an example of the potential change of the pixel electrode when polarity is changed from negative polarity to positive polarity between frames. FIG. 10C shows an example of the potential change of the pixel electrode when polarity is changed from negative polarity to negative polarity between frames. FIG. 10D shows an example of the potential change of the pixel electrode when polarity is changed from positive polarity to positive polarity between frames. A potential Vx which is formed by correction based on the tone potential Vd is applied to the data line 121 during the scanning line ON period Ton in respective examples.

FIG. 10A and FIG. 10B show the transition with time of the data line potential DP and the pixel electrode potential PP after correction when the polarity differs between the frames. FIG. 10A shows the example of a case where the polarity of the data line potential DP is changed from positive polarity to negative polarity between the Mth frame and the (M+1)th frame. In this case, a correction value (Vx−Vd) is set to Vb1. FIG. 10B shows the example of a case where the polarity of the data line potential DP is changed from negative polarity to positive polarity between the Mth frame and the (M+1)th frame. In this case, a correction value (Vx−Vd) is set to Vb2.

FIG. 10C and FIG. 10D show the transition with time of the data line potential DP and the pixel electrode potential PP after correction when the same polarity is used between the frames. FIG. 10C shows the example of a case where the polarity of the data line potential DP is changed from negative polarity to negative polarity between the Mth frame and the (M+1)th frame. In this case, a correction value (Vx−Vd) is set to Vb3. FIG. 10D shows the example of a case where the polarity of the data line potential DP is changed from positive polarity to positive polarity between the Mth frame and the (M+1)th frame. In this case, a correction value (Vx−Vd) is set to Vb4.

Here, Vb1 to Vb4 are values which differ from each other based on the relationship between the polarity of the data line potential and the image data of the Mth frame and the (M+1)th frame. For example, when the data line potential DP is changed from positive polarity to negative polarity (FIG. 10A), the relationship of Vb1<0 is established. When the data line potential DP is changed from negative polarity to positive polarity (FIG. 10B), the relationship of Vb2>0 is established. When the data line potential DP is changed from negative polarity to negative polarity (FIG. 10C), the relationship of Vb3<0 is established. When the data line potential DP is changed from positive polarity to positive polarity (FIG. 10D), the relationship of Vb4>0 is established. Further, compared to the case where the change of the data line potential DP takes place between the frames of the same polarity (FIG. 10C and FIG. 10D), the correction amount is increased in the case where the change of the data line potential DP takes place between the frames of the different polarities (FIG. 10A and FIG. 10B). Accordingly, the relationship of Vb1<Va1<0<Va2<Vb2 is established. Further, since the correction based on polarity change is performed, when the potential before the data line potential is applied in FIG. 10A and the tone potential Vd in FIG. 10B are equal and the tone potential Vd in FIG. 10A and the potential before the data line potential is applied in FIG. 10B are equal, the relationship of |Vb1|>|Vb2| is also satisfied.

Hereinafter, the correction amount (Vb1) for correcting the tone potential to the data line potential when the tone potential which allows any pixel circuit to display the display tone in the (M+1)th frame is the first potential of positive polarity and the tone potential which allows the pixel circuit to display the display tone in the Mth frame is the second potential of negative polarity is called a first correction amount, and the correction amount (Vb2) for correcting the tone potential to the data line potential when the tone potential which allows any pixel circuit to display the display tone in the (M+1)th frame is the second potential and the tone potential which allows the pixel circuit to display the display tone in the Mth frame is the first potential is called a second correction amount. In this circumstance, the first correction amount and the second correction amount differ from each other. By setting the correction amounts in this manner, the correction of the data line potentials which conforms to asymmetry of the circuits can be realized.

Embodiments of the present invention are not limited to the constitutions explained heretofore. The constitutions explained heretofore are provided only as examples of the present invention.

For example, in obtaining the potential Vx of the data line potential DP in high frame rate driving, it may not be necessary to calculate all correction amounts of data line potential DP. Set values of data line potentials which are the combination of the polarity and the display tone in the Mth frame and the combination of the polarity and the display tone in the (M+1)th frame may be preliminarily stored in a lookup table for every frame rate. By looking up the stored lookup table, the potential Vx of the data line potential DP for every frame rate is determined, and this potential is applied to the data line 121. In this case, for example, when the display tone is a value of 8 bits (256 tones), the data line potential also has values of 256 stages. Further, to take the constitution that the data line potential has 2 patterns of positive polarity and negative polarity into consideration, the data line potential may have values of 512 stages. Due to the combination of the image data and the polarities in the Mth frame and the (M+1)th frame, as the correction amount patterns, 262144 patterns (=512×512 patterns) may be stored in the lookup table. The lookup table is physically stored in a storage means.

It is not always necessary to hold the correction amounts in the lookup table with respect to all combinations of the polarity and the display tone. For example, when the change amount of the data line potential is small or the like, the correction may be omitted. Further, the present invention is not limited to the case where one data line potential corresponds to one display tone. In other words, the display tone and the data line potential are not limited to the univocal relationship. Accordingly, the size of the lookup table is not limited to the above-mentioned size.

By adopting the constitutions explained heretofore, the display device of the present invention can set the data line potentials which are corrected corresponding to the writing shortage attributed to the decrease of an image data writing period and the deviation which occurs due to polarity inversion patterns between the frames thus realizing a favorable display when the high frame rate driving is performed.

### Second Embodiment

Hereinafter, a liquid crystal display device according to a second embodiment of the present invention is explained. The liquid crystal display device according to the second embodiment differs from the liquid crystal display device according to the first embodiment with respect to a point that a correction amount is changed based on a temperature of a liquid crystal display panel. Hereinafter, the explanation is made by mainly focusing on points which make this embodiment differ from the first embodiment.

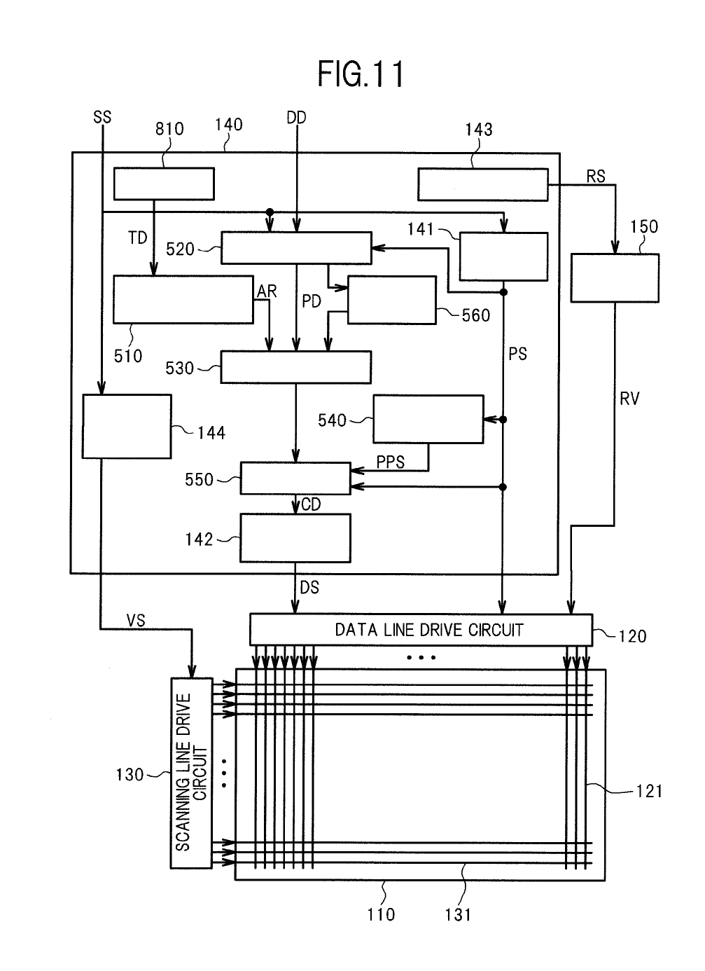

FIG. 11 shows an example of the liquid crystal display device according to the second embodiment of the present invention. A control circuit 140 of the liquid crystal display device according to this embodiment includes a polarity signal generation part 141, a data line control signal generation part 142, a reference voltage control part 143, a scanning line control signal generation part 144, a tone potential arrival rate output circuit 510, a tone potential calculation circuit 520, a tone potential correction circuit 530, a frame polarity storage part 540, a polarity correction circuit 550 and a tone potential storage part 560. The control circuit 140 also includes a temperature observation part 810.

The temperature observation part 810 observes temperature around a liquid crystal display panel 110, and outputs temperature data TD as a result of observation. The tone potential arrival rate output circuit 510 calculates a tone potential arrival rate based on a value indicative of a scanning line ON period Ton such as a frame rate and the temperature data TD, and The tone potential arrival rate output circuit 510 outputs the tone potential arrival rate. The processing for correcting a tone potential Vd which image data DD indicates using the tone potential arrival rate output circuit 510, the tone potential calculation circuit 520, the tone potential correction circuit 530, the frame polarity storage part 540, the polarity correction circuit 550 and the tone potential storage part 560 is substantially equal to the corresponding processing performed in the first embodiment except for a point that the tone potential arrival rate is used and hence, the detailed explanation of the processing is omitted.

Due to such a constitution, when a characteristic of a pixel circuit is changed due to a temperature change, and an arrival rate of data line potential DP applied to a pixel electrode 220 via a TFT element is changed due to temperature unless this method is adopted, it is possible to set the data line potential by adding a correction amount to a data line potential writing arrival rate so that the liquid crystal display device of this embodiment can perform a favorable display.

### Third Embodiment

Hereinafter, a liquid crystal display device according to a third embodiment of the present invention is explained. The liquid crystal display device according to the third embodiment differs from the liquid crystal display device according to the second embodiment with respect to a point that the liquid crystal display device has a frame rate conversion function. Hereinafter, the explanation is made by mainly focusing on points which make this embodiment differ from the second embodiment.

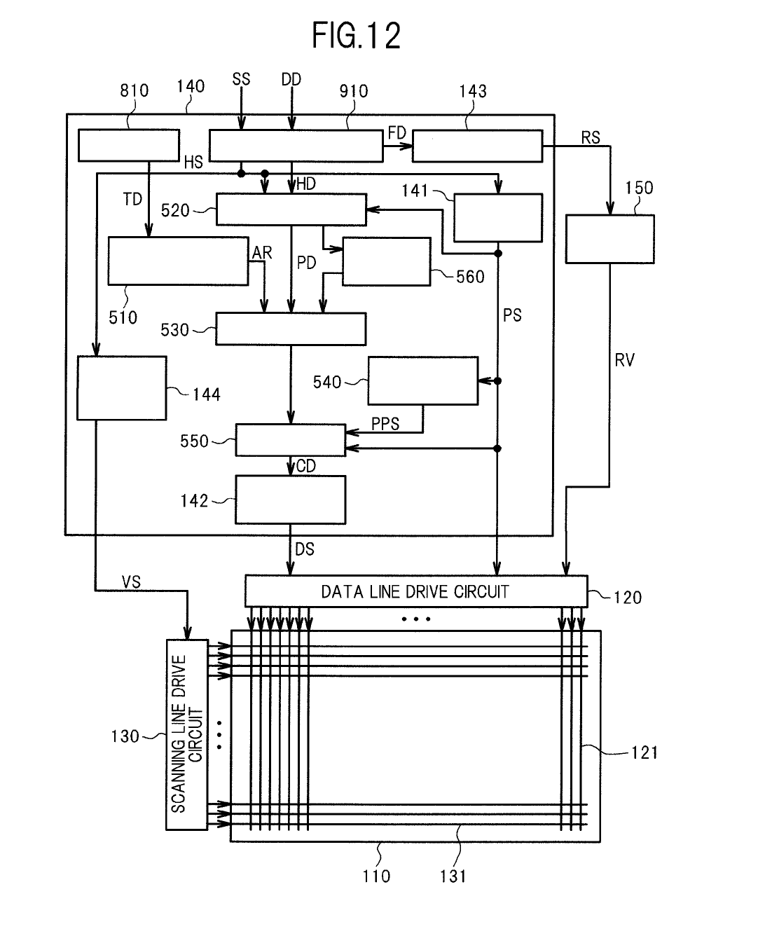

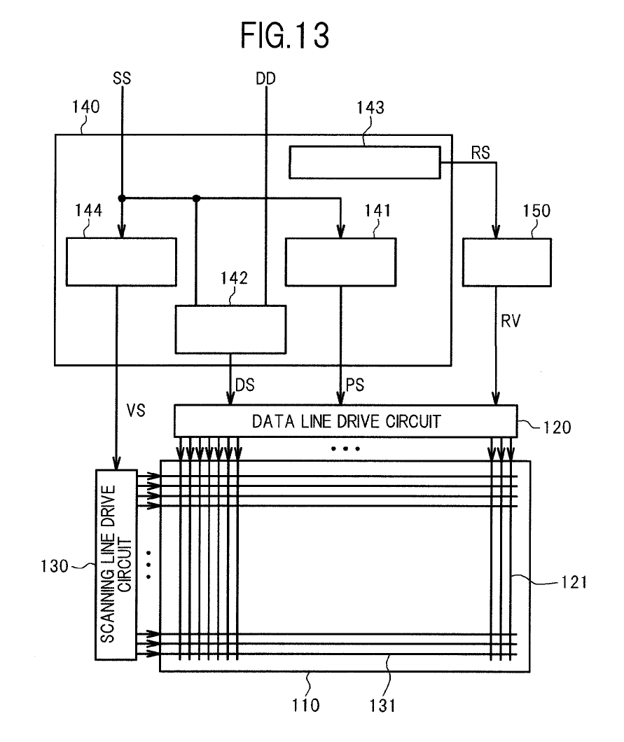

FIG. 12 shows an example of the liquid crystal display device according to the third embodiment of the present invention. A control circuit 140 of the liquid crystal display device according to this embodiment includes a polarity signal generation part 141, a data line control signal generation part 142, a reference voltage control part 143, a scanning line control signal generation part 144, a tone potential arrival rate output circuit 510, a tone potential calculation circuit 520, a tone potential correction circuit 530, a frame polarity storage part 540, a polarity correction circuit 550, a tone potential storage part 560 and a temperature observation part 810. The control circuit 140 also includes a frame rate conversion circuit 910.

The frame rate conversion circuit 910, when image data DD inputted from the outside is of a low frame rate, converts the image data DD into a high frame rate image data HD which is image data of a high frame rate, and outputs the high frame rate image data HD to the tone potential calculation circuit 520 in the control circuit 140. Further, the frame rate conversion circuit 910, when timing data SS inputted from the outside is of a low frame rate, converts the timing data SS into a high frame rate timing data HS which is timing data of a high frame rate, and outputs the high frame rate timing data HS. The tone potential calculation circuit 520 calculates a tone potential Vd for displaying display tone which the high frame rate image data HD indicates, and outputs the tone potential Vd as tone potential data PD. In the same manner as the other embodiments, data on the tone potential Vd which is preliminarily calculated for every display tone may be stored in a memory and the data on the tone potential Vd corresponding to the display tone which the high frame rate image data HD indicates may be obtained and outputted from the memory. Further, the scanning line control signal generation part 144 and a polarity signal generation part 145 are operated based on the high frame rate timing data HS in place of the timing data SS.

By allowing the frame rate conversion circuit 910 included in the control circuit 140 to output the high frame rate image data HD and the high frame rate timing data HS of a high frame rate, the liquid crystal display device can display the image data of a low frame rate as the image data of a high frame rate.

Further, by inputting frame rate data FD to the reference voltage control part 143 corresponding to a frame rate, the control circuit 140 can output a reference voltage RV which conforms to a frame rate.

By constituting the display device in the above-mentioned manner, the liquid crystal display device can display an image without generating the degradation of image quality in high frame rate driving.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device comprising:
a data line;
a plurality of pixel circuits each of which includes a transistor and a pixel electrode;
a data line drive circuit which applies a data line potential to the transistor included in each of the pixel circuits via the data line; and
a control circuit which allows the data line drive circuit to apply the data line potential which is formed by correcting a tone potential which allows the pixel circuit to display a display tone thereof based on information indicative of the display tone of each of the pixel circuits, wherein
the pixel electrode which is included in each of the pixel circuits is connected to the data signal line via the transistor included in the pixel circuit, and
the control circuit controls the data line drive circuit in such a manner that an amount of correction from a first potential to the data line potential when a tone potential of each of the pixel circuits in a frame which is displayed assumes the first potential and a tone potential of the pixel circuit in a frame right before the frame which is displayed assumes a second potential which differs from the first potential, and an amount of correction from the second potential to the data line potential when the tone potential of the pixel circuit in the frame which is displayed assumes the second potential and the tone potential of the pixel circuit of the frame right before the frame which is displayed assumes the first potential differ from each other.

2. The liquid crystal display device according to claim 1, wherein the control circuit controls the data line drive circuit in such a manner that an amount of correction from a positive potential to the data line potential when the tone potential of each of the pixel circuits in the frame which is displayed assumes the positive potential and the tone potential of the pixel circuit of the frame right before the frame which is displayed assumes a negative potential, and an amount of correction from the negative potential to the data line potential when the tone potential of the pixel circuit in the frame which is displayed assumes the negative potential and the tone potential of the pixel circuit of the frame right before the frame which is displayed assumes the positive potential differ from each other.

3. The liquid crystal display device according to claim 2, wherein the control circuit comprises:
a tone potential calculation part which obtains a value indicative of a tone potential which allows the pixel circuit to display the display tone based on information indicative of the display tone;
a tone potential correction part which outputs a value indicative of an enhanced potential which is formed by correcting the tone potential of the frame which is displayed based on potential difference between the tone potential of the frame which is displayed and the tone potential of the frame right before the frame which is displayed;
a polarity correction part which outputs data indicative of the data line potential which is formed by correcting the enhanced potential based on polarity of a potential applied to the pixel electrode in the frame which is displayed and polarity of a potential applied to the pixel electrode in the frame right before the frame which is displayed; and
a data line control signal generation part which performs a control so as to allow the data line drive circuit to apply the data line potential.

4. The liquid crystal display device according to claim 3, further comprising a temperature observation part which measures a temperature, and the tone potential correction part calculates a value indicative of the enhanced potential based on information indicative of the display tone and the measured temperature.

5. The liquid crystal display device according to claim 1, wherein the control circuit includes:
a storage means which stores values indicative of the data line potentials corresponding to the display tone and the polarity of the frame which is displayed and the display tone and the polarity of the frame right before the frame which is displayed; and
a data line control signal generation means which performs a control such that the data line drive circuit applies the data line potential based on information indicative of the display tone of each of the pixel circuits, a polarity of the potential applied to the data line in the frame which is displayed, a polarity of the potential applied to the data line in the frame right before the frame which is displayed, and the values indicative of the data line potentials stored in the storage means.

6. The liquid crystal display device according to claim 2, wherein the control circuit inverts the polarity of the potential which the data line drive circuit applies to the data line every time 2 or more predetermined frames are displayed.

7. The liquid crystal display device according to claim 1, wherein the control circuit further includes a frame rate conversion means which acquires image data of a frame rate lower than a frame rate at which the control circuit is operated and converts the image data into information indicative of the display tone at the frame rate at which the control circuit is operated.
